(19) United States
(12) Patent Application Publication
(10) Pub. No.: US 2015/0260340 A1
(43) Pub. Date: Sep. 17, 2015

(54) TANK CONTAINER

(71) Applicant: WEW WESTERWÄLDER EISENWERK GMBH, Weitefeld (DE)

(72) Inventors: Dieter Pfau, Elkenroth (DE); Kevin Tannenberger, Kirchen (DE)

(21) Appl. No.: 14/431,248

(22) PCT Filed: Aug. 26, 2013
(86) PCT No.: PCT/EP2013/067620

§ 371 Date: Mar. 25, 2015

(30) Foreign Application Priority Data
Sep. 25, 2012 (DE) 102012109015.7

(51) Int. Cl. F17C 3/12

(52) U.S. Cl. CPC F17C 3/12; F17C 2201/0104; F17C 2203/012; F17C 2203/0604; F17C 2203/0653

(57) ABSTRACT

The invention relates to a tank container (1) including a cylindrical vessel (3), the ends of which are closed by domed bottoms (5), and provided with an inner lining (6), in particular lead lining, and being connected at the bottoms (5) in each case by way of an annular device (13) to an end frame device (9). The annular device (13) is provided in a rim region (15) of the bottom (5). Between the annular device (13) and the bottom, in the rim region (15), a frustoconical annular support element (17, 17′) extends concentrically to the annular device (13). It engages flush by way of a broad side (25) with the outside (27) of the rim region (15) and is fixed on its inner and outer edge (29, 31) by way of welding seams (33, 35) to the rim region (15), such that loads acting between the vessel (3) and the annular device (13) are transmitted by way of the broad side (25) between the vessel (3) and the annular support element (17, 17′).

### FIELD OF THE INVENTION

The present invention relates to a tank container including a cylindrical vessel, the ends of which are closed by domed bottoms and which includes an inner lining, in particular, a lead coating.

### BACKGROUND OF THE INVENTION

Tank containers are employed for the transportation of a variety of chemical products. In this context, in known tank container constructions a horizontally-disposed, cylindrical vessel is connected at its ends by way of a support structure to end frames. Such a support structure is, for example, known from DE 78 06 797 U1. The end frames by way of their corner castings provide the interface for transportation and transloading of the tank container. Usually, the support structure takes the form of an annular device, which is welded to the portion of the tank bottom surrounded by the rim region and which is connected at its opposite end to the end frame. The tank bottoms usually take the form of torispherically-curved bottoms (e.g. dished torispherical heads, deep-dished torispherical bottoms, ellipsoidal bottoms). Such tank containers having an end ring are, for example, known from DE 32 12 696 C2 and from DE 29 705 851 U1.

The tank construction materials, such as fine-grained structural steels or chromium nickel steels normally used for tank containers, are not suitable for some cargoes, because they are too badly attacked by such content materials. For the protection of the inner surfaces against such particularly aggressive content materials a variety of coatings and/or linings are known (rubberlining, phenolic resin coatings, enameling, galvanizing). These linings form a permanent barrier between the cargo and the container construction material. However, as a rule, they are not suitable to absorb the loads to be transferred between the frame and the tank. Rather, the mechanical load absorption takes place by way of the stable container construction material (as a rule, a metallic construction material). Numerous linings and coatings are elastically or plastically deformable and adapt readily to the deformations of the container which it undergoes under load. For the transportation of high-purity or very aggressive media, container tanks of fiber-reinforced plastic are also known. Thus, e.g. from EP 1033328 A1.

However, there also known such coatings and linings which are very brittle, such that even the slightest deformations give rise to cracks (e.g. vitreous enamel) or crystalline dislocations, which destroy the protective effect of such linings, because the content material then passes through the damaged inner coating to the container construction material, causing its decomposition.

Bromine is a particularly critical content material, which can only be screened off effectively and in the long term diffusion-resistantly by way of a lead coating. By being rendered passive, lead is chemically very stable and as a result resists inter alia sulfuric acid and bromine. Accordingly, it is employed in apparatus and container construction as corrosion protection. Tank containers as well are known for transporting bromine by virtue of lead-lined vessels.

For that purpose, the interior of a steel vessel is first cleaned and tin-coated. Subsequently, the lead coating is fused onto the tin coating. The tin coating thus serves as a bonding agent between the lead and the steel. Lead itself is a soft, plastically-deformable construction material. However, its passive layer forming the corrosion barrier is very brittle, and its structure is damaged even if minor deformations take place, and then no longer serves as a tight barrier.

In order to prevent this, the vessels of known bromine tank containers are accommodated in their cylindrical region in an expansive support bed, which is intended to prevent or limit deformations of the vessel to such an extent that the lead lining and, in particular, its passive layer is neither damaged during transport nor during transloading. These known support means are however heavy and their manufacture is expensive. Moreover, the weight of the container which, as a result of the leading lining is already greatly increased, is further increased by the required heavy support and frame construction, and the already limited transport volume is further diminished.

The known end frame constructions are only suited to a limited extent to their employment with lead-lined vessels, because there is a risk that, due to the comparatively small contact area between the annular support structure and the bottom, high stresses arise due to load effects. As a result thereof, the bottom is deformed to such an extent that the internal lead lining is damaged and can no longer be effective as a protective barrier between the content material (bromine) and the vessel.

A conceivable partial solution would be to increase the wall thickness of the domed end bottoms to such an extent that the arising loads can no longer result in effective deformation. However, this would result likewise in a considerable weight increase, which is undesirable.

The object of the present invention resides in providing a tank container with a light-weight end ring design, which is also suitable for accommodating a cylindrical vessel having an inner lining, in particular a lead lining.

### SUMMARY OF THE INVENTION

According to a first aspect, the present invention provides a tank container, which includes a cylindrical vessel, the ends of which are closed by domed bottoms and which are provided with an inner lining, in particular, a lead lining. In this context, the bottoms are each connected by way of an annular means to an end frame device, the annular means of the vessel being provided in a rim region of the bottom and, between the annular means and the bottom, a frustoconical annular support element, corresponding to the rim region, extending concentrically to the annular means. This annular support element by way of its broad side (the inner surface of the frustoconical means) on the tank side is tangentially in flush engagement with the exterior side of the rim region and is connected along its inner and outer edges to the rim region of the bottom by way of welding seams, in such a manner that loads acting between the vessel and the annular means are transferred, spread out by way of the annular support element, between the vessel and the annular means.

Thus, the frustoconical annular support element serves as a support area, which transfers the loads transferred by the annular device more widely spread out into the vessel bottom. Due to the annular support element being provided in the rim region, the loads are introduced into a particularly dimensionally stable region of the vessel bottom. In this manner, deformations caused by the loads are further minimized. The welding seams extending along the inner and outer edges of the annular support element additionally increase the contact region and additionally increase the configurational stability, because the region outlined by the rim region, the annular support element and the welding seams forms a closed structure (annular closed profile), which additionally increases the configurational stability and thereby counteracts any deformation of the bottom in that region, such that even comparatively thin-walled bottoms can be provided with a lead lining.

Further aspects and features of the present invention will be apparent from the subsidiary claims, the accompanying drawing and the following description of preferred embodiments.

### CONCISE DESCRIPTION OF THE DRAWING

Embodiments of the invention will be described by way of example with reference to the Figures. Shown therein are:

FIG. 1 A diagrammatic side elevation of a tank container according to the invention,

FIG. 2 A detailed (partial section A) of the tank container illustrated in FIG. 1, and

FIG. 2a an alternative embodiment of the annular support element shown in FIG. 2.

### DESCRIPTION OF WORKING EMBODIMENTS

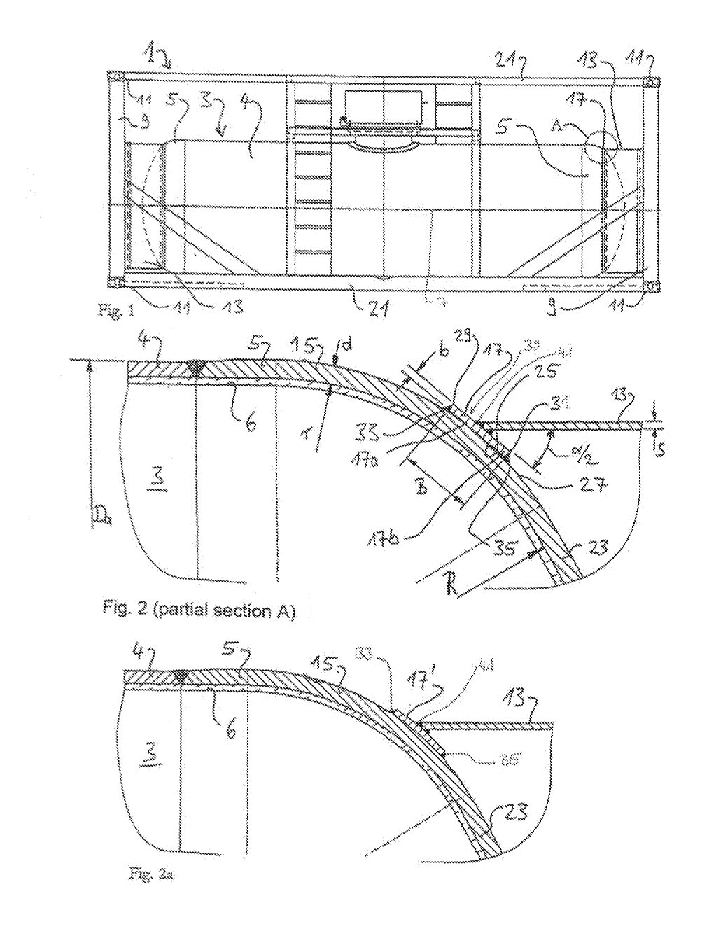

FIGS. 1 and 2 show an embodiment according to the invention. Prior to their detailed description, some general elucidations of further embodiments are provided in what follows.

In an embodiment of the tank container, the angle of conicity a of the annular support is between 60° and 100° and preferably between 70° and 90°. In that manner, the load application, in particular of loads acting in the longitudinal direction, is improved. This is so because in that manner the load component acting longitudinally is applied further outwardly and in longitudinal direction into the cylindrical jacket. The deformation effect of such loads onto the bottom is minimized.

In an embodiment, in which a width B of the annular support is so provided that it covers between 20% and 30% of the exterior area of the rim region, the load transfer surface (the broad surface of the annular support, i.e. the inner side of the cone) is so large that a very effective load distribution over the bottom rim takes place. At the same time, due to the limited outer surface area to 30%, it is ensured that the configurational rigidity of the overall structure: rim region, annular support and welding seams remains ensured.

In one embodiment, the ratio of the wall thickness b of the annular support and the wall thickness d of the rim region of the bottom is between 1:1 and 1:3. This ensures an effective increase of the previously available bottom wall thickness. On the other hand, this ensures that in the event of loading, when this occurs, the annular support element will adapt initially to the shape and configuration of the rim region, thereby absorbing the deformation energy, which no longer can act on the bottom rim.

In one embodiment the wall thickness r of the cylindrical tubular member, which constitutes a part of the support structure (annular support means), is so adapted to the wall thickness b of the annular support that their respective wall thicknesses do not differ from one another by more than 20%. In that manner, no appreciable sudden changes in rigidity occur between these two elements, and during welding on both sides, a substantially full-surface engagement socket is formed which applies the loads from the cylindrical tubular member into the annular support in a widely-distributed manner, such that a smooth load transmission between these two elements can be ensured.

In this context, in one embodiment the tubular member is so fitted to the annular support that the respective limb lengths of the limb outside of the tubular member and that of the limb inside of the tubular member are in a ratio to one another of 1:2 to 2:1. That is to say, the tubular member is affixed approximately within the central one third of the annular support. In this manner it is ensured that even the outermost and innermost edges of the limbs effectively engage in the load transmission and the load application, and that the desired load transfer with little deformation remains ensured.

In one embodiment, in this context, the welding seams along the edges of the annular support, its wall thickness and its width are so designed that seam shrinkage occurring during congealing of the welding seams adapts the broad side of the annular support element to the outside of the bottom rim, such that it enters into flush surface engagement with the rim region. During welding of the annular support with straight limbs (conical configuration), fillet welds are formed along the outer and inner edges of the annular support. Prior to being welded on, the annular support engages the outside of the rim region in linear contact (annular) tangentially with its broad side. The fillet welds formed along the edges shrink during congealing of the molten liquid and exercise a tensile force onto the edges of the annular support and draw these closely towards the exterior surface of the rim region. This occurs both along the inner as well as the exterior edge of the annular support element, whereby the latter adopts the curvature of the rim region of the bottom. As a result, the annular support element across its surface area is in flush relation to the bottom rim and adapts, without laborious prior shaping, even, on occasion, to somewhat variably curved rim regions. This configurational adaptation improves the large area load injection, which prevents deformation of the bottom and thereby damage to the inner lining (i.e. a lead lining and its passive layer).

Referring now to FIGS. 1 and 2, these show a tank container 1 according to the invention, including the vessel 3, which at its ends is closed by the domed bottoms 5. The vessel 3 is of cylindrical configuration and extends along the tank axis 7.

The domed bottom 5 is welded to the cylindrical portion 4 of the vessel 3, the inner surface of the vessel being provided completely with a lead layer 6, forming an inner lining, which (and, in particular, its passive layer) serves as a corrosion barrier against a content material, e.g. bromine.

Along its ends, end frame devices 9 with corner castings 11 are provided. Between each end frame device 9 and the domed bottom 5 an annular member 13 extends which by way of a frustoconical annular support element 17 is fitted to the rim region 15 of the bottom 5. The end frame devices 9 may optionally be interconnected additionally by way of longitudinal frame elements 21.

In the working example illustrated, the domed bottom 5 is designed as a so-called deep-dished torispherical bottom or ellipsoidal bottom, the configuration of which is defined by the outer diameter Da of the cylindrical vessel 3. The (toroidally-arched) rim region 15 in this case has a radius r=0.154 Da and the spherical cap region 23 (spherically domed) has a radius R of 0.8 Da. Slightly different ratios apply to so-called [shallow] dished torispherical bottoms: r=0.1 Da, R=Da.

The annular support element 17 has a width B and a wall thickness b and tangentially engages with its inner broad side 25 the outside 27 of the rim region 15. The inner and outer edge 29 and 31 are each welded circumferentially by way of the welding seams 33 and 35 to the outside 27 of the rim region 15. The tapering angle α of the annular support element amounts to about 80°.

The annular device 13 takes the form of a tubular member, the end 37 on the tank side of which is welded to the outside 39 of the annular support element 17, approximately in its central third region, such that a wholly-continuous seam connection 41 on the outside and on the inside of the tubular member 13 is ensured. The tubular member 13 meets the annular support element 17 in such a manner that it divides the latter into an outer limb 17a and an inner limb 17b and that the limb lengths are in a ratio of 1:1.

In the working example illustrated, the width B of the annular support element 17 is so selected that the broad side 25 covers approximately 25 percent of the outer side 27 of the rim region 15. The wall thickness b of the annular support element 17 corresponds to the wall thickness s of the tubular member 13 and amounts to 0.4 times the wall thickness d of the bottom 5 in its rim region 15.

FIG. 2A shows a working example in which the annular support element 17′, which at its inner and outer edges 29 and 31 is welded by way of welding seams 33 and 35 to the rim region 15, and is adapted to the curvature of the rim region 15 due to the shrinkage of the welding seams 33 and 35. Thus, starting from its original frustoconical configuration it adopts a toroidally-curved configuration and engages flush with the rim region 15.

Further embodiments will be apparent within the context of the claims.

### LIST OF REFERENCE NUMBERS

1: Tank container
3: Vessel
4: Cylindrical portion
5: Domed bottom
6: Internal lining
7: Tank axis
9: End frame device
11: Corner castings
13: Annular member/tubular member
15: Rim region
17: Annular support element
17a: Outer limb
17b: Inner limb
21: Longitudinal frame element
23: Spherical cap region
25: Broad side
27: Outside rim region
29: Inner edge
31: Outer edge
33: Welding seam
35: Welding seam
37: Tank-side end
39: Outside annular support element
41: Seam connection

1. A tank container including
a cylindrical vessel, the ends of which are closed by domed bottoms, and which is provided with an inner lining and is connected at the bottoms in each case by way of an annular device to an end frame device,
wherein the annular device is provided in a rim region of the bottom, a frustoconical annular support element extending concentrically to the annular device between the annular device and the bottom in the rim region,
the annular support element, by way of a broad side being in flush engagement with the outer side of the rim region and being connected at its inner and outer edges by way of welding seams to the rim region,
so that loads acting between the vessel and the annular device are transferred by way of the broad side between the vessel and the annular support element.

2. The tank container according to claim 1, wherein the angle of conicity α of the annular support element is between 60° and 100°.

3. The tank container according to claim 1, wherein a width (B) of the annular support element is so provided that it covers between 20 and 30% of the outer surface area of the rim region.

4. The tank container according to claim 1, wherein the ratio of a wall thickness (b) of the annular support element and a wall thickness of the rim region is between 1:1 and 1:3.

5. The tank container according to claim 1, wherein the annular device includes, connected to the annular support a cylindrical tubular member, the wall thickness of which amounts to 90 to 110% of the wall thickness.

6. The tank container according to claim 5, wherein the tubular member defines at the annular support element an inner and an outer limb, and wherein the inner and the outer limb lengths are provided in a ratio of 1:2 to 2:1.

7. The tank container according to claim 1, wherein the welding seams, a wall thickness and a width of the annular support element are so designed and adapted to one another that the seam shrinkage occurring during congealing of the welding seams causes the broad side of the annular support element to adapt to the configuration of the outside such that the broad side engages flush with the rim region.

8. The tank container according to claim 1, wherein the inner lining is formed of lead.

9. The tank container according to claim 2, wherein the angle of conicity a of the annular support element is between 70° and 90°.
